(19) United States
(12) Patent Application Publication
(10) Pub. No.: US 2002/0161618 A1
(43) Pub. Date: Oct. 31, 2002

(54) Integrated scheduler and material control system

(76) Inventors: Mitchell Weiss, Carlisle, MA (US); Douglas Lawson, Westford, MA (US); Thomas Mariano, Londonderry, NH (US); Robert Gaskins, Littleton, MA (US); Namdar Bahri, Hopkinton, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 09/804,971

(22) Filed: Mar. 13, 2001

(51) Int. Cl. G06F 17/60; G06F 19/00

(52) U.S. Cl. 705/8; 700/113

(57) ABSTRACT

An integrated scheduler/material control system that receives a plurality of material move requests and prioritizes these move requests according to a critical pick-up time associated with each move request. Using vehicle utilization data from the traffic management system, the integrated scheduler/material control system determines the number of move requests to be deferred to a later time period and then calculates the number of move requests to be executed in the current time period. The integrated scheduler/material control system then passes the move requests and the number of move requests to be executed to the traffic management system in the prioritized order.

### CROSS REFERENCE TO RELATED APPLICATIONS

N/A

### STATEMENT REGARDING FEDERALLY SPONSORED RESEARCH OR DEVELOPMENT

N/A

### BACKGROUND OF THE INVENTION

This invention relates generally to a material control system in a network-like, vehicle-based, material handling system and in particular to a material control system that assigns priorities to jobs by a critical pick-up time associated with each job and that utilizes a feedback control system to monitor the status and performance of the material handling system to compensate for varying demands.

Electrically powered material transport vehicles (MTVs) are often used in manufacturing and warehouse environments for transporting and manipulating articles of manufacture. Such vehicles are desirable in such environments due to their clean operation and low noise. Often one or more MTVs are propelled along a fixed rail or track by an electric motor under the control of a traffic management system. The traffic management system typically receives material move requests from the material control system. This allows the traffic management system to control the allocation of the MTVs to various jobs and also to control the movement of the MTVs along a predetermined path.

In particular, computer controlled materials transport systems are known for moving materials among various work stations of a facility. Such systems are employed, as an example, in semiconductor fabrication facilities for moving semiconductor wafers to successive work stations. In one type of a wafer transport system, a monorail track is routed past the work stations and a plurality of MTVs are mounted on the track and are moveable thereon. The MTVs are responsible for delivering the wafers to a work station for processing and for removing the wafers from the work station after the requisite processing operations have been completed. The track is composed of a series of interconnected track sections that usually include one or more routing sections or modules that are operative to provide plural paths along the track. In general a node in such a system is a location where a vehicle is stopped, loaded, unloaded, or redirected. Thus, a node can be a workstation that a vehicle must pass through or an intersection of one or more tracks where the vehicle may be redirected.

In such a material handling system, the vehicles on the track typically operate in a connected mode of operation. In the connected mode of operation, a central traffic management system, which usually includes a computer, allocates MTVs to move certain material lots, assigns destinations to the MTVs, and monitors the overall operation of the material handling system. This monitoring may include monitoring the status and location of each MTV, the status and location of the material lots that are needed to be transported, and the status of each node of the material transport system.

The central traffic management system is, therefore, responsible for the execution of material lot move requests to transport a material lot from a source node to a destination node. These requests are typically initiated by the material control system. As such the central traffic management system is responsible for allocating MTVs to each move request to be executed and for monitoring the execution of each move request. Typically, the material control system operates as an open loop controller and initiates the incoming move requests on a first-in-first-out (FIFO) basis. Because the material control system is an open loop controller, the allocation of MTVs is not a function of the current traffic conditions, MTV availability, or any problems in the processing stages. As such typical material control systems are unable to respond to changing conditions and other problems in the material handling system that may arise and negatively impact the ability to execute incoming move requests. This can result in inconsistent delivery times, MTVs remaining in queues at various nodes wasting the system resources, and delaying of processing of material batches due to executing move requests in a sub-optimal manner.

Therefore, it would be desirable to provide an integrated scheduler and material control system that ranks move requests according to a due time current system conditions and that increases the probability of on time material delivery.

### BRIEF SUMMARY OF THE INVENTION

An integrated scheduler/material control system receives a plurality of material move requests and prioritizes these move requests according to a critical pick-up time associated with each move request. Using vehicle utilization data from the traffic management system, the integrated scheduler/material control system determines the number of move requests to be deferred to a later time period and then calculates the number of move requests to be executed in the current time period. The integrated scheduler/material control system then passes the prioritized move requests and the number of move requests to be executed to the traffic management system for execution.

A system and method for prioritizing the execution of move requests includes providing an ordered list of move requests within a material control system, wherein the ordered list includes a prioritized list of move requests. The system and method include a material control system that receives a plurality of move requests and determines a critical pick-up time for each of the plurality of move requests. The material control system ranks the plurality of move requests in an ordered list and calculates the number of move requests to be deferred to a future time period. Using the number of move requests to be deferred to a future time period, the material control system calculates the number of move requests to be executed in the current time period. The material control system initiates the next move request to the traffic controller in the ordered list until the number of executed move requests exceeds the number of move requests to be executed in the current time period. The move requests may also be ranked according to the due time associated with each move request, and the move requests executed sequentially in their ranked order.

Additional aspects, features and advantages of the present invention are also described in the following Detailed Description.

### BRIEF DESCRIPTION OF THE SEVERAL VIEWS OF THE DRAWING

The invention will be more fully understood by reference to the following Detailed Description of the Invention in conjunction with the drawings of which:

FIG. 1 is a schematic view of an exemplary topography of an automated material handling system;

FIG. 2 is a block diagram of a traffic management system in accordance with the present invention;

FIGS. 3A and 3B are a flow chart illustrating a method of traffic management in accordance with the present invention;

FIG. 4 is a representation of the critical pick-up time; and

FIG. 5 is a block diagram of a feedback control system in accordance with the present invention.

### DETAILED DESCRIPTION OF THE INVENTION

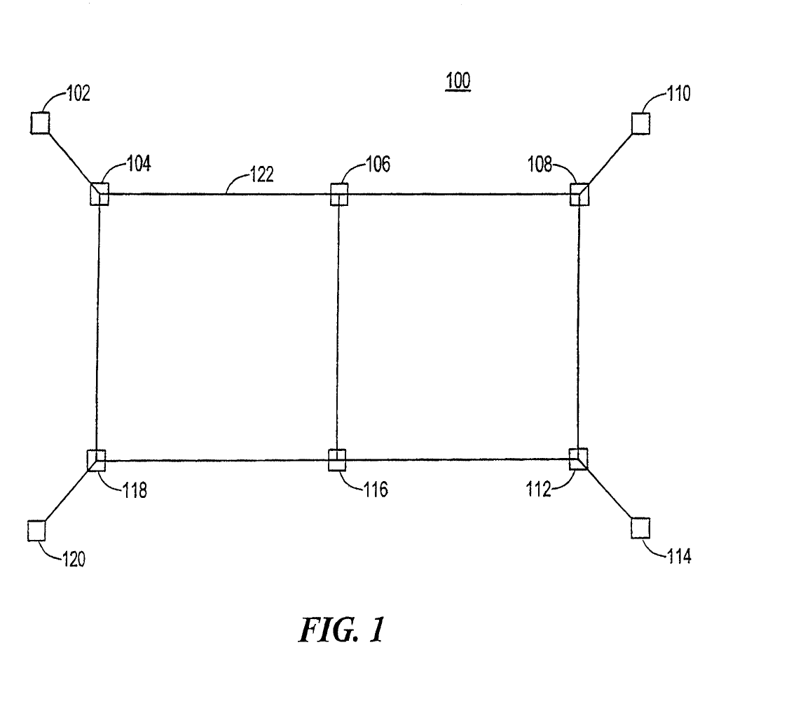

In accordance with the present invention, a material control system supervises the material transport vehicle (MTV) traffic in a material handling system by first prioritizing received move requests based on the critical pick-up time associated with each move request and then utilizing a closed-loop feedback control system to monitor one or more system parameters and adjust the number of move requests being executed. FIG. 1 illustrates an exemplary topology 100 of a material transport system (MTS) in which ten nodes are interconnected by a track 122. As illustrated in FIG. 1 for example, node 104 connects to nodes 102, 106, and 118. Also as illustrated in FIG. 1 multiple routes are available for a material transport vehicle (MTV) to use in retrieving material from a node or transporting material to another node. For example, to travel from node 102 to node 120 some of the possible paths are nodes 102-104-118-120; nodes 102-104-106-116-118-120; nodes 102-104-106-108-112-116-118-120.

As used herein a “move request” is a request from a host to a material control system (MCS) and includes a source node, a destination node, a due time and a time-stamp. The host integrates both the data from an manufacturing execution system (MES) and a scheduler. The MES contains various process flow data, such as process routing data and process tool data. The scheduler receives this process flow data and determines when a material lot is needed at a particular node to be processed by a particular tool. The host integrates this process flow data and schedule data and provides a move request to the MCS. As used herein a “source node” is a node or station that a material lot is waiting to be transported from, to a destination node. The MTV retrieves the material lot and proceeds to the destination node. As used herein the “destination node” is the node or station that receives the MTV material lot delivery. The topology illustrated in FIG. 1 is an arbitrary topology intended to be for illustrative purposes only and in no way is meant to be limiting. A traffic management system (not shown) controls the distribution and delivery of materials, via the MTVs.

The material control system divides time into a series of discrete time periods and analyzes a plurality of move requests to determine which move requests are to be executed within the next time period. The material control system receives a plurality of move requests and prioritizes these move requests in an ordered list according to a predetermined metric. The material control system determines how many of the move requests in the ordered list are to be executed in the next time period based on the current conditions of the AMHS. The material control system then selects the particular move requests from the prioritized ordered list that will be executed in the next time period.

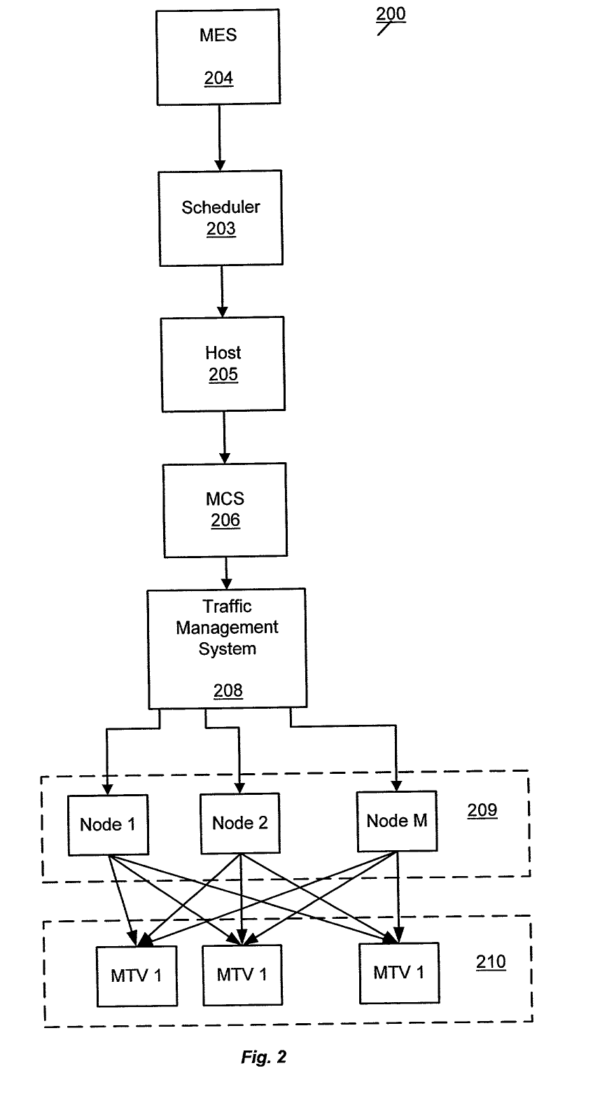

To accomplish this, as illustrated in FIG. 2, a material control system 206 a MES 204 that provides process flow data to a scheduler 203. The scheduler 203 analyzes the process flow data and provides process schedule data to a host 205. The host 205 integrates the process flow data and the process schedule data and provides this data to an MCS 206 that controls a traffic management system 208.

The MES contains process flow data that describes, in addition to other process data, the process stages, tools, and process routes used within the manufacturing environment. The scheduler 206 receives this process flow data and determines a process schedule that may include data for a particular material lot that should be delivered to a station or tool at a particular time for processing. This may allow the scheduler to minimize some aspect of the manufacturing process such as time, expense, power consumption, or other manufacturing metrics. The scheduler 203 provides this process schedule data to the host 205 that integrates this data into a series of move requests. The move requests are provided to the MCS 206, and the MCS 206 analyzes the move requests and provides a series of move requests to the traffic management system 208. This list may be prioritized or otherwise ranked according to various criteria. The traffic management system 208 provides control information to the various nodes 209 that provide the lowest level of control of the assignment and routing of the plurality of MTVs 210 available to execute the move requests. Alternatively, the scheduler, host and MCS functionality do not have to be provided individually, but can be integrated together.

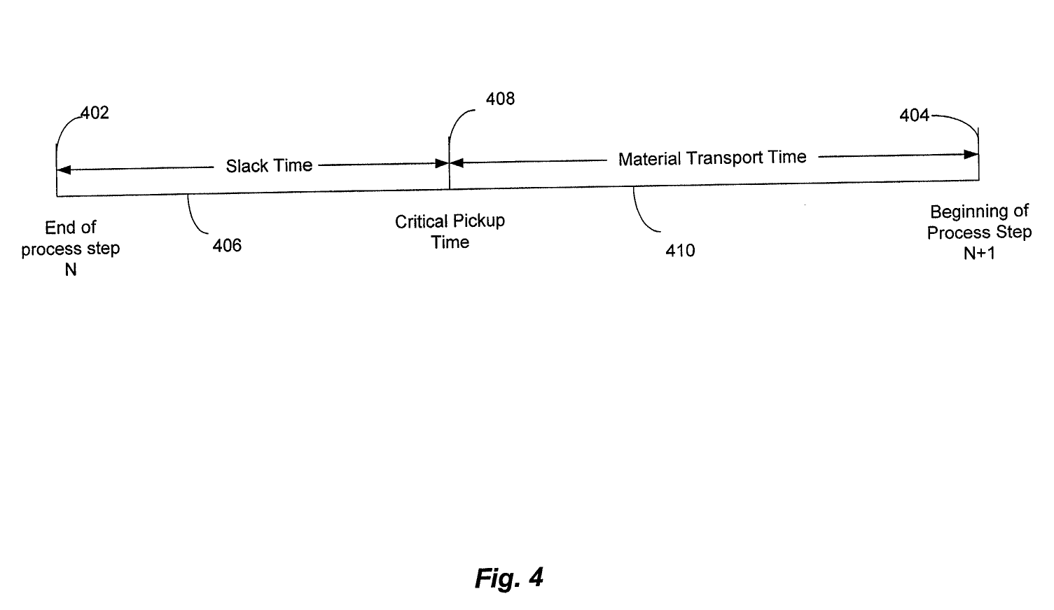

The MCS 206 prioritizes the move requests by calculating a critical pick-up time associated with each received move request. The MCS 206 uses the “due time” associated with a material lot that defines when the material lot must be delivered to a particular node to determine the critical pick-up time of the material lot. FIG. 4 graphically illustrates the critical pickup time of a movement request. The end of the previous process step “n” 402 and the beginning of the next step “n+1”404 mark the end points of a time-line that limits the movement of a material lot from one processing stage to another. There is associated with any movement within the system an average transport time that is necessary to move a material lot from one node to another. This average transport time is a function of the route selected for the MTV to traverse between the source and destination nodes, the average speed of the MTV along the selected route, and any other delays along the route such as the time required to redirect an MTV. Thus, the critical pick-up time 408 is the time of the beginning of the next step 404 minus the average transport time 410 from the due time of the material lot at the appropriate node. The MCS 206 prioritizes the received move requests according to the critical pick-up time associated with each move request. In particular, the MCS 206 provides a higher priority or ranking to a move request having an associated critical pickup time that is closer in time to the present. In one embodiment, the ranked move requests could be executed in this ranked order. If more move requests are received by the MCS 206, the MCS will determine the critical pickup time for each newly received move request and provide a ranking of the move request according to the determined critical pickup time. The newly ranked move request is then inserted appropriately in the ranked list.

Alternatively, the MCS 206 could first prioritize the move requests based on the due time associated with a particular move request. In this embodiment the move requests could be executed in the order in which they are ranked. Additionally, a second prioritization or ranking can be used, wherein the MCS calculates the critical time as described above based on the due time of the lot. If more move requests are received by the MCS 206, the MCS 206 will rank each newly received move request according to the due time associated therewith and provide a ranking of the move request according to the determined due time. The newly ranked move request is then inserted appropriately in the ranked list.

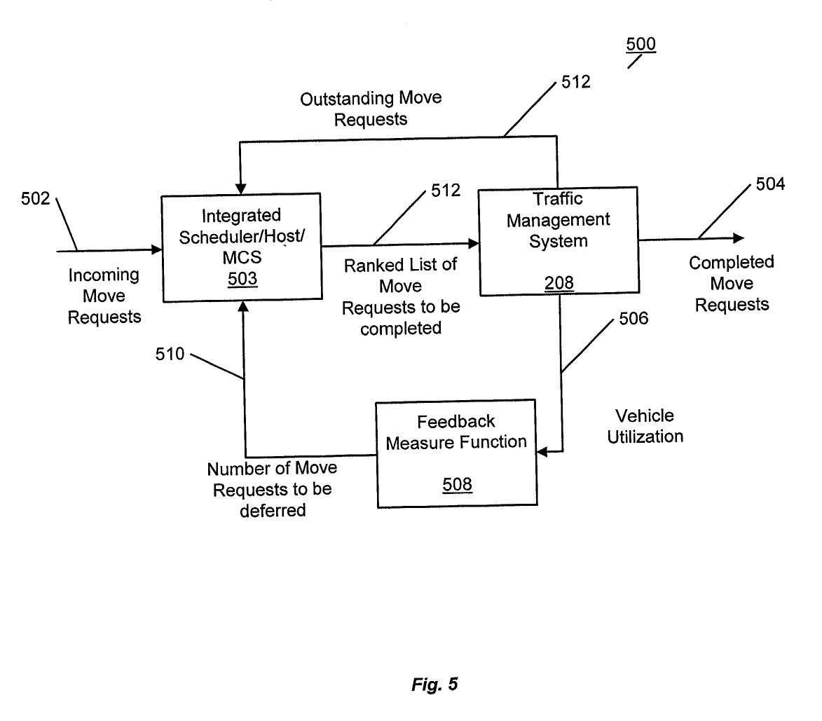

As illustrated in FIG. 5, a feedback control system 500 is depicted that includes an integrated scheduler/host/MCS 503 and the traffic management system 208. In a typical feedback controller paradigm, the scheduler/host/MCS 208 is the controller, the traffic management system 208 is the process to be controlled, and the feedback function 508 provides a measure of system performance to the controller. Incoming material lot move requests 502 and outstanding move requests 514 are input to the integrated scheduler/host/MCS 503 and prioritized according to their associated critical pick-up time as described above. The outstanding move requests 514 are the move requests that were not executed by the traffic management system 208 during the previous time period and are provided to the integrated scheduler/host/MCS 206 by the traffic management system 208. The traffic management system 208 receives the prioritized move requests 516 and either immediately executes these requests, or queues the unexecuted move requests to return to the scheduler/host/MCS 206 as the outstanding move requests 514. The traffic management system 208 provides an output of the completed move requests 510. The feedback function 508 receives the vehicle utilization percentage 512 provided by the traffic management system 208 and computes the number of move requests to be deferred to the next time period 510. The feedback function 508 may be used to either dampen or increase the move requests to be executed based on the vehicle availability 512.

The following equations may be derived from the system illustrated in FIG. 5:

ΦM−C (1)

$$\begin{matrix}V = \frac{\partial C}{\partial t} \cdot \frac{T}{n} & ( 2 ) \\ M = I + Φ - \frac{H}{V} . & ( 3 )\end{matrix}$$

Where Φ is the queue of outstanding moves, M are the moves to be completed by the traffic management system, C is the output of completed moves, V is the vehicle utilization, T is the average delivery time, n is the number of vehicles in the AMHS, I is the queue of incoming move requests, H is the number of moves to be deferred. By taking the derivative of equations (1) and (3) and solving for H, a feedback measure that is a function of time, incoming move requests, vehicle utilization, and completed move requests is determined.

$$\begin{matrix}\frac{\partial Φ}{\partial t} = \frac{\partial M}{\partial t} - \frac{\partial C}{\partial t} ⇒ \frac{\partial M}{\partial t} = \frac{\partial Φ}{\partial t} + \frac{\partial C}{\partial t} & ( 4 ) \\ \frac{\partial M}{\partial t} = \frac{\partial I}{\partial t} + \frac{\partial Φ}{\partial t} - \frac{1}{V} \cdot \frac{\partial H}{\partial t} . & ( 5 )\end{matrix}$$

From equation (2) we can see that:

$$\frac{\partial C}{\partial t} = \frac{V \cdot n}{T} . \qquad ( 6 )$$

Solving equation (5) for ∂H/∂t and substituting from equation (4) and (6) yields:

$$\frac{\partial H}{\partial t} = V ( \frac{\partial I}{\partial t} - \frac{\partial C}{\partial t} ) \qquad ( 7 )$$

and therefore,

$$H = {\int }_{{t}_{i}}^{{t}_{i + 1}} V ( \frac{\partial I}{\partial t} - \frac{\partial C}{\partial t} ) \partial t . \qquad ( 8 )$$

The feedback measure H can be calculated for very small dt and integrated over the time period tᵢ to tᵢ₊₁. H is then substituted in equation (3) and M, the number of moves to be completed by the AMHS in the next time period is calculated. By artificially setting a maximum number of move requests for a given time period, the remaining moves are in effect deferred until the next time period. Since the incoming material lot move requests are prioritized based on the critical pickup time rule described above, only the highest priority move requests are forwarded to the AMHS for execution.

The above described scheduler/host/MCS 503 therefore, controls the number of MTVs being utilized during a given time period. During periods of high usage the scheduler/host/MCS 503 reduces the number of move requests executed during a given time period to reduce the stress placed on the material transport system during periods of high usage. In this way, only the move requests having the highest priority will be executed and move requests having lower priorities, i.e., that have a critical pick-up time further in the future will be delayed to a time period with less demand. Similarly, during periods of low vehicle usage the scheduler/host/MCS 503 increases the number of move requests executed during a given time period to utilize the resources of the material handling system more efficiently. Thus, the scheduler/host/MCS 503 will reduce the vehicle utilization during peak demand, and will increase the vehicle utilization during low demand periods and will provide a smoother vehicle utilization with fewer dramatic increases or decreases in the number of vehicles used. Therefore, the highest priority move requests are ensured of delivery in a minimum amount of time since the number of vehicles moving and delivering material lots is controlled by the scheduler/host/MCS 206 based on the condition of the MTS. This reduces the probability of traffic jams and backups at busy nodes or MTVs waiting in queues.

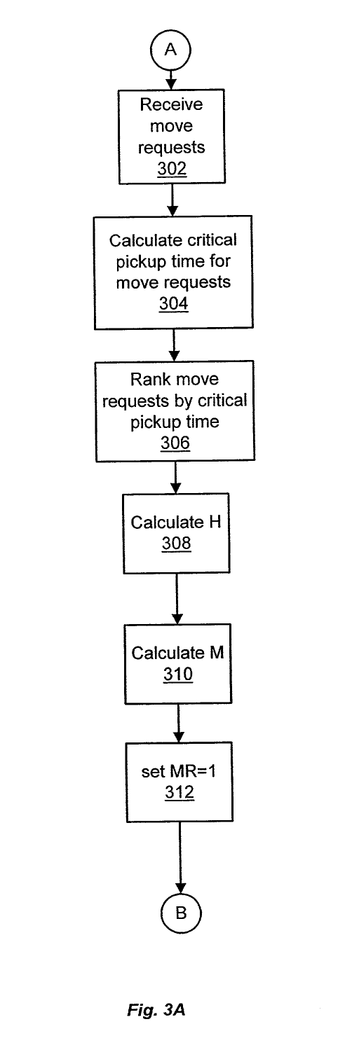

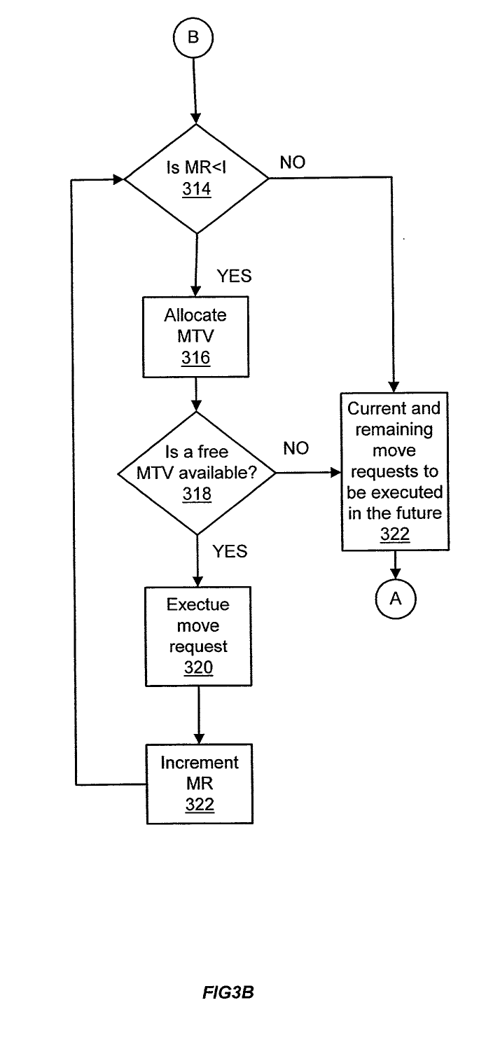

The operation of the presently described integrated scheduler, host, and MCS with reference to FIG. 5 is described below with respect to the flow diagram depicted in FIGS. 3A and 3B. Referring to FIGS. 3A and 3B the integrated scheduler/host/MCS receives incoming move requests as illustrated in step 302. The integrated scheduler/host/MCS calculates the critical pickup time for each of the received move requests as illustrated in step 304. The integrated scheduler/host/MCS prioritizes the received move requests according to their associated critical pickup times as illustrated in step 306. As described above, the integrated scheduler/host/MCS calculates the feedback function H that is used to calculate the number of move requests to be deferred to the next time period as illustrated in step 308. As described above, the integrated scheduler/host/MCS uses the calculated value for H to calculate the value of M, the number of move requests to be executed in the next time period, as illustrated in step 310.

An index indicative of the number of move requests that have been executed is initialized at one (1) as illustrated in step 312. The index number of the executed move requests is checked against the number of moves to be completed, as illustrated in step 313. If the next move request index number is less than the number of move requests, then the next move request is passed to the traffic management system for execution, as illustrated in step 314. If the next move request index number is greater than the number of move requests, then the next move request and the subsequent move requests having a lower priority are queued for execution in the next time period as illustrated in step 326, and the method then returns to step 302. As illustrated in step 318, if the traffic management system receives the next move request to be executed the traffic management system allocates an MTV to carry out the move request. A check is made to determine if there is an available MTV to allocate, as illustrated in step 320. If there is an available MTV to be allocated, the MTV is allocated and the move request is executed as illustrated in step 322. The index indicative of the number of move requests that have been executed is incremented and the method passes back to step 313 to begin the execution of the next move request. If no MTV is available to execute the move request, the current move request and subsequent move requests having a lower priority are queued for execution in the next time period as illustrated in step 326. The method then returns to step 302.

Those of ordinary skill in the art should further appreciate that variations to and modification of the above-described methods and apparatus for an integrated scheduler and material control system may be made without departing from the inventive concepts disclosed herein. Accordingly, the invention should be viewed as limited solely by the scope and spirit of the appended claims.

1. A method for scheduling the pick-up and delivery of material in a predetermined time period for an automated material handling system having material transport vehicles, the method comprising:
receiving a plurality of move requests;
determining a critical pickup time for each of the plurality of move requests;
ranking the plurality of move requests in a ranked list according to the critical time determined for each move request;
calculating the number of move requests to be deferred to a future time period;
calculating the number of move requests to be executed in the predetermined time period; and
executing the next ranked move request until the number of executed move requests exceeds the number of move requests to be executed.

2. The method of claim 1 wherein the step of executing further includes the steps of:
determining if a material transport vehicle can be allocated to execute the executing move request;
if a material transport vehicle can be allocated, allocating the material transport vehicle; and
executing the move request;
else if no material transport vehicle can be allocated, returning the move request and subsequent move requests remaining in said ranked list to be processed in a future time period.

3. The method of claim 1 wherein the step of ranking includes the steps of:
determining the critical pickup time for each of the plurality of move requests; and
ranking the move requests according to the critical pickup time in said ranked list;

4. The method of claim 3 wherein the step of calculating the critical pickup time includes the steps of:
determining time of the process at step n+1
determining the material transport time from a source node to a destination node;
subtracting the material transport time from the time of the process at step n+1.

5. An apparatus for scheduling a plurality of move requests, the apparatus comprising:
an traffic management system having an input and a first output of a plurality of outstanding move requests, a second output of a plurality of completed move requests, and a third output of a vehicle utilization parameter;
a prioritizing module configured and arranged to receive the plurality of move requests, the plurality of outstanding move requests, and a feedback parameter, the prioritizing module being operative to determine the number of move requests to be executed in a particular time period and to prioritize the plurality of move requests and the plurality of outstanding move requests according to a critical pick-up time associated with each of the plurality of move requests, the prioritizing module operative to provide a plurality of prioritized move requests equal to the number of move requests to be executed to the input of the automated material handling system;
a feedback module receiving the vehicle utilization parameter from the automated material handling system, determining the number of move requests to be deferred, and providing the number of move requests to be deferred as the feedback parameter to the prioritizing module.

6. The apparatus of claim 5 wherein the traffic management system includes:
a locator module receiving as an input a move request to be executed, the locator module operative to locate a free material transport vehicle and to assign the material transport vehicle to execute the input move request.

7. A method for scheduling the pick-up and delivery of material in an automated material handling system having material transport vehicles, the method comprising:
receiving a plurality of move requests, including a due time associated with each move request;
ranking the plurality of move requests in a ranked list; and
executing the ranked move requests sequentially.

8. The method of claim 7 wherein the step of ranking includes the steps of ranking the move requests according to the due time associated with each of the move requests.

9. The method of claim 8 wherein the step of calculating the critical pickup time includes the steps of:
determining time of the process at step n+1 equivalent to the due time;
determining the material transport time from a source node to a destination node;
subtracting the material transport time from the time of the process at step n+1.

10. The method of claim 7 wherein the step of executing further includes the steps of:
determining if a material transport vehicle can be allocated to execute the executing move request;
if a material transport vehicle can be allocated, allocating the material transport vehicle; and
executing the move request;
else if no material transport vehicle can be allocated, returning the move request and subsequent move requests remaining in said ranked list to be processed in a future time period.

11. The method of claim 7 further comprising the steps of:
receiving at least one additional move request;
ranking the received at least one additional move request;
inserting the ranked received at least one additional move request into the ranked plurality of move requests at an appropriate location.

12. The method of claim 7 wherein the step of executing the ranked move requests comprises the steps of:
calculating the number of move requests to be deferred to the future;
calculating the number of move requests to be presently executed; and
executing the next ranked move request until the number of executed move requests exceeds the number of move requests to be presently executed.
